(19) United States
(12) Patent Application Publication
(10) Pub. No.: US 2013/0190163 A1
(43) Pub. Date: Jul. 25, 2013

(54) DIELECTRIC CERAMIC AND ELECTRONIC COMPONENT USING THE SAME

(71) Applicant: TDK CORPORATION, Tokyo (JP)

(72) Inventors: Toshio SAKURAI, Tokyo (JP); Kiyoshi HATANAKA, Tokyo (JP); Masaharu HIRAKAWA, Tokyo (JP)

(73) Assignee: TDK CORPORATION, Tokyo (JP)

(21) Appl. No.: 13/715,282

(22) Filed: Dec. 14, 2012

(30) Foreign Application Priority Data
Jan. 20, 2012 (JP) 2012-009523
Nov. 6, 2012 (JP) 2012-244300

(51) Int. Cl. H01B 3/12

(52) U.S. Cl. CPC H01B 3/12
USPC 501/134

(57) ABSTRACT

A dielectric ceramic contains Mg₂SiO₄ as a main component, and TiO₂, Al₂O₃, and Li₂O as subcomponents, wherein, based on 100 parts by mass of the main component, the TiO₂ content is 0.5 parts by mass or more and 5.0 parts by mass or less in terms of oxide, the Al₂O₃ content is 0.5 parts by mass or more and 3.0 parts by mass or less in terms of oxide, and the Li₂O content is 1.0 part by mass or more and 3.0 parts by mass or less in terms of oxide.

### BACKGROUND OF THE INVENTION

1. Field of the Invention

The present invention relates to a dielectric ceramic used in a high-frequency region such as a microwave region, and to an electronic component using the ceramic.

2. Description of the Related Art

In recent years, high-frequency bands called “quasi-microwave bands” of several hundreds MHz to several GHz have been used in mobile communication devices such as cellular phones and the like in increasing demand. Therefore, electronic components used in mobile communication devices, such as a capacitor, a filter, a resonator, a circuit board, and the like, are required to have characteristics suitable for use in high-frequency bands.

A circuit board which is one of the electronic components used in high-frequency bands is provided with conductors (hereinafter referred to as “conductor materials”) such as an electrode, wiring, and the like, and includes a built-in low-cut (LC) filter formed by combining a magnetic material and a dielectric material and a built-in capacitor formed by combining a high-dielectric constant material and a low-dielectric constant material, forming a circuit including the LC filter and the capacitor.

In order to decrease signal delay due to an inter-wire capacitance in a wiring layer, it is necessary to decrease relative dielectric constant εr of the circuit board. Also, in order to prevent attenuation of high-frequency signals, it is necessary to increase a Q·f value (i.e., decrease a dielectric loss) of the circuit board. Therefore, materials required for the circuit board are dielectric materials having low relative dielectric constant εr and a high Q·f value at a working frequency, wherein Q is a reciprocal of tangent (tan δ) of loss angle δ which is a difference between a phase difference between actual current and voltage and a phase difference of 90 degrees between ideal current and voltage, and f is a resonance frequency. The Q·f value is represented by the product of quality factor Q (=1/tan δ) and resonance frequency f. The dielectric loss decreases as the Q·f value increases.

In general, many low-dielectric constant materials have low dielectric losses and are used in devices in the microwave region. For example, a LC filter is formed by simultaneously firing a high-dielectric constant material and a low-dielectric constant material. When in a LC filter, a low-dielectric constant material having a high Q value is used in a portion constituting a L portion in order to provide a high self resonance frequency to a ceramic material, and a high-dielectric constant material having good temperature characteristics is used in a C portion, a LC device having a high Q value and good temperature characteristics can be realized.

In order to simultaneously fire a conductor material and a dielectric material, a dielectric material (low-temperature co-fired ceramic (LTCC) material) capable of low-temperature firing is required. In order to perform low-temperature firing, a low-melting-point oxide (Li₂O, B₂O₃, MoO₃, Bi₂O₃, or the like) or glass (SiO₂—B₂O₃-alkali metal oxide-alkaline earth oxide, zinc borosilicate glass, or the like) is used as a subcomponent. In particular, glass containing Li₂O is known to be a very effective subcomponent for low-temperature firing because of its low softening point.

Japanese Unexamined Patent Application Publication No. 10-242604 discloses a technique concerning control of an amount of amorphous phase produced in firing of lithium silicate-based glass in which forsterite (metal oxide crystal phase) is mixed as a filler. However, using the Li₂O-containing glass as a subcomponent of the LTCC material causes the problem of deterioration in dielectric characteristics, particularly deterioration in Q value, and deterioration in mechanical strength, thereby causing difficulty in satisfying both water resistance and characteristics including electrical and mechanical properties. Japanese Unexamined Patent Application Publication No. 2009-132579 discloses a technique of using forsterite as a main component and adding a lithium compound (Li₂O) as a subcomponent. However, this technique also causes the same problem as the above.

### SUMMARY OF THE INVENTION

Accordingly, it is an object of the present invention to provide a dielectric ceramic which has excellent dielectric characteristics and which can be fired at a low temperature and can be compactly sintered even when using a Li₂O-containing compound. Also, it is another object of the present invention is to provide a dielectric ceramic allowed to maintain water resistance so that a test surface for reliability can be maintained in a high-temperature high-humidity environment, and provide an electronic component using the ceramic.

In order to resolve the problem and achieve the objects, the inventors intensively researched a dielectric ceramic and an electronic component using the same. As a result, a dielectric ceramic containing Mg₂SiO₄ as a main component and TiO₂, Al₂O₃, and Li₂O as subcomponents was produced, wherein based on 100 parts by mass of the main component, the TiO₂ content is 0.5 parts by mass or more and 5.0 parts by mass or less in terms of oxide, the Al₂O₃ content is 0.5 parts by mass or more and 3.0 parts by mass or less in terms of oxide, and the Li₂O content is 1.0 part by mass or more and 3.0 parts by mass or less in terms of oxide. In addition, an electronic component including a dielectric layer composed of the dielectric ceramic was produced, resulting in the achievement of the objects.

Accordingly, it is possible to provide a dielectric ceramic, even when using a Li₂O-containing compound, capable of low-temperature firing and securing sinterability, having excellent dielectric characteristics, and being allowed to maintain water resistance so that a test surface for reliability can be maintained in a high-temperature and high-humidity environment.

### DESCRIPTION OF THE PREFERRED EMBODIMENTS

A preferred embodiment for carrying out the resent invention (hereinafter referred to as an “embodiment”) is described in detail below. The present invention is not limited to the contents described below in the embodiment below. In addition, constituent features in the embodiment described below include those which can be easily conceived by a person skilled in the art and substantially the same features, i.e., those in an equal range. Further, the constituent features disclosed in the embodiment described below can be properly combined.

<Dielectric Ceramic>

A dielectric ceramic according to the embodiment contains Mg₂SiO₄ as a main component and TiO₂, Al₂O₃, and Li₂O as subcomponents.

In the embodiment, the dielectric ceramic refers to a sintered body produced by sintering a dielectric composition. In addition, the term “sintering” represents a phenomenon that a dielectric composition is converted to a sintered body by heating, producing a compact body. The sintered body (dielectric ceramic) generally has a higher density, higher mechanical strength etc. as compared with the dielectric composition before heating. The sintering temperature is a temperature at which the dielectric composition is sintered. Further, “firing” represents a heating treatment for sintering, and a firing temperature is a temperature of an atmosphere in which the dielectric composition is exposed during the heating treatment.

Whether or not the dielectric composition can be fired at a low temperature (low-temperature sinterability) can be evaluated by determining whether or not the dielectric composition is sintered by firing at gradually increasing firing temperatures to produce the dielectric ceramic according to the embodiment having desired dielectric high-frequency characteristics. In addition, the dielectric characteristics of the dielectric ceramic according to the embodiment can be evaluated by a Q·f value, a change in resonance frequency with temperature change (temperature coefficient tf of resonance frequency), and relative dielectric constant εr. The Q·f value and relative dielectric constant εr can be measured according to “Testing Method for Dielectric Properties of Fine Ceramics at microwave Frequency” of the Japanese Industrial Standards (JIS R1627, 1996).

<Main Component>

The dielectric ceramic according to the embodiment contains Mg₂SiO₄ (forsterite) as a main component. Since a simple substance of Mg₂SiO₄ has a Q·f value of 200,000 GHz or more and a low dielectric loss, it has the function of decreasing a dielectric loss of the dielectric ceramic. In addition, Mg₂SiO₄ has a relative dielectric constant εr of as low as about 6 to 7, it also has the function of decreasing the relative dielectric constant εr of the dielectric ceramic. The dielectric loss is a phenomenon that part of high-frequency energy is dissipated as heat. As described above, the magnitude of dielectric loss is represented by tangent (tan δ) of a loss angle δ which is a difference between a phase difference between an actual current and voltage and a phase difference of 90 degrees between an ideal current and voltage. Therefore, a reciprocal Q (Q=1/tan δ) of tan δ is used as an expression of loss reduction. The dielectric loss of the dielectric ceramic is evaluated by using the Q·f value which is the product of Q and resonance frequency f. The Q·f value increases as the dielectric loss decreases, and the Q·f value decreases as the dielectric loss increases. Since the dielectric loss represents the power loss of a high-frequency device, the dielectric ceramic preferably has a large Q·f value. In this embodiment, the dielectric loss is evaluated using the Q value.

With respect to a molar ratio between MgO and SiO₂ constituting Mg₂SiO₄, a MgO/SiO₂ ratio is stoichiometrically 2:1, but in the present invention, the ratio is not limited to this and may be deviated from the stoichiometric ratio within a range which does not impair the advantage of the present invention. For example, the MgO/SiO₂ ratio may be within a range of 1.9:1.1 to 2.1:0.9.

The content of Mg₂SiO₄ in the dielectric ceramic according to the embodiment is preferably the balance remaining after subcomponents described below are removed from the whole dielectric ceramic. When the dielectric ceramic contains Mg₂SiO₄ as the main component under this condition, the effect of decreasing the dielectric loss and relative dielectric constant εr can be securely achieved.

<Subcomponent>

The dielectric ceramic according to the embodiment is composed of TiO₂, Al₂O₃, and Li₂O as the subcomponents relative to Mg₂SiO₄ as the main component. The subcomponents are used as sintering aids which form a liquid phase during firing of the dielectric composition. In particular, Li₂O-containing glass functions as a liquid phase and promotes reaction of the sintering aids remaining unreacted with Mg₂SiO₄ as the main component. This can result in a decrease in amount of the sintering aids remaining unreacted in the dielectric ceramic after firing of the dielectric composition or can cause complete reaction of the sintering aids, thereby securing sinterability of the dielectric ceramic. Consequently, the Q value of the resultant dielectric ceramic can be improved. In addition, TiO₂ functions to crystallize an unreacted portion of glass component. This produces the function of improving water resistance. In addition, TiO₂ has a high Q value and can thus increase the Q value of the dielectric ceramic and can decrease the dielectric loss because sinterability of the dielectric ceramic is secured. Further, Al₂O₃ may be added in the form of a single oxide as the subcomponent or added as a Li₂O-containing glass composition containing Al₂O₃ in order to improve chemical durability of glass. Also, Al₂O₃ has the function of crystallizing an unreacted portion of the glass component. Therefore, Al₂O₃ has the function of improving water resistance. In addition, when the subcomponents having glass softening points of 450° C. or more and 650° C. or less are used as sintering aids, the subcomponents perform the function as a liquid phase, accelerating reactivity between the sintering aids remaining unreacted and Mg₂SiO₄ as the main component. This can decrease the amount of the sintering aids remaining unreacted in the dielectric ceramic after firing of the dielectric composition or can cause complete reaction of the sintering aids, thereby securing sinterability of the dielectric ceramic.

The content of TiO₂ as the subcomponent is preferably 0.5 parts by mass or more and 5.0 parts by mass or less and more preferably 1.0 part by mass or more and 3.0 parts by mass of less in terms of oxide based on 100 parts by mass of the main component. When the TiO₂ content is less then 0.5 parts by mass, the function of crystallizing an unreacted portion of the glass components cannot be achieved, failing to impart water resistance. As a result, the Q·f value is decreased, and the dielectric ceramic with a low loss cannot be produced. While when the TiO₂ content exceeds 5.0 parts by mass, insufficient sintering is caused, failing to impart water resistance. Further, the Q·f value is decreased, and the dielectric ceramic with a low loss cannot be produced.

The content of Al₂O₃ as the subcomponent is preferably 0.5 parts by mass or more and 3.0 parts by mass or less and more preferably 1.0 part by mass or more and 2.0 parts by mass or less in terms of oxide based on 100 parts by mass of the main component. When the Al₂O₃ content is less then 0.1 parts by mass, the function of crystallizing an unreacted portion of the glass components cannot be achieved, failing to impart water resistance. As a result, the Q·f value is decreased, and the dielectric ceramic with a low loss cannot be produced. While when the Al₂O₃ content exceeds 3.0 parts by mass, insufficient sintering is caused, failing to impart water resistance. Further, the Q·f value is decreased, and the dielectric ceramic with a low loss cannot be produced.

The content of Li₂O as the subcomponent is preferably 1.0 part by mass or more and 3.0 parts by mass or less and more preferably 1.0 part by mass or more and 2.0 parts by mass or less in terms of oxide based on 100 parts by mass of the main component. When the amount of Li₂O added is less then 1.0 part by mass, sinterability of the dielectric ceramic cannot be secured, failing to impart water resistance. Further, the Q·f value is decreased, and the dielectric ceramic with a low loss cannot be produced. While when the adding amount exceeds 3.0 parts by mass, the amount of unreacted portion of the glass component is increased, causing a limit to crystallization and failing to impart water resistance. Further, the Q·f value is decreased, and the dielectric ceramic with a low loss cannot be produced.

When Li₂O is added in the form of a Li₂O-containing glass composition containing Al₂O₃, chemical durability of glass is improved, and Al₂O₃ has the function of crystallizing an unreacted portion of the glass component. The glass component is preferably composed of, for example, either or both of SiO₂—O—Li₂O—Al₂O₃ (RO contains at least one alkaline-earth metal oxide)-based glass and B₂O₃—RO—Li₂O—Al₂O₃-based glass. Examples of the glass component include SiO₂—RO—Li₂O—Al₂O₃-based glass such as SiO₂—CaO—Li₂O—Al₂O₃-based glass, SiO₂—SrO—Li₂O—Al₂O₃-based glass, SiO₂—BaO—Li₂O—Al₂O₃ -based glass, SiO₂—SrO—CaO—Li₂O—Al₂O₃-based glass, SiO₂—SrO—BaO—Li₂O—Al₂O₃-based glass, SiO₂—CaO—BaO—Li₂O—Al₂O₃-based glass, and the like; and B₂O₃—RO—Li₂O—Al₂O₃-based glass such as B₂O₃—CaO—Li₂O—Al₂O₃-based glass, B₂O₃—SrO—Li₂O—Al₂O₃-based glass, B₂O₃—BaO—Li₂O—Al₂O₃-based glass, B₂O₃—SrO—CaO—Li₂O—Al₂O₃-based glass, B₂O₃—SrO—BaO—Li₂O—Al₂O₃-based glass, B₂O₃—CaO—BaO—Li₂O—Al₂O₃-based glass, and the like. Among these, SiO₂—CaO—BaO—Li₂O—Al₂O₃-based glass is preferred. As a result, the function of improving water resistance is achieved. In addition, using the glass component having a glass softening point of 450° C. or more and 650° C. or less produces the function as a liquid phase and improves reactivity between the sintering aids remaining unreacted and Mg₂SiO₄ as the main component. A glass softening point of lower than 450° C. causes foaming in the sintered body and decreases the Q·f value, failing to achieve the dielectric ceramic having a low loss. While a glass softening point of higher than 650° C. causes insufficient sintering in firing at a low temperature of 900° C. or less, failing to achieve the compact dielectric ceramic. Therefore, the glass component having a glass softening point of 450° C. or more and 650° C. or less is used. As a result, the amount of the sintering aids remaining unreacted in the dielectric ceramic after firing of the dielectric composition can be decreased, or the sintering aids can be completely reacted, thereby securing sinterability of the dielectric ceramic.

### EXAMPLES

Examples for carrying out the present invention are described in detail below. The present invention is not limited to the contents described below in the examples. In addition, constituent features described below include those which can be easily conceived by a person skilled in the art and substantially the same features. Further, the constituent features described below can be properly combined.

First, MgO and SiO₂ powders used as raw materials of Mg₂SiO₄ were weighed according to a predetermined mass ratio and mixed together with pure water and a commercial anionic dispersant using a ball mill for 24 hours to prepare mixed slurry. The mixed slurry was dried by heating at 120° C., then disintegrated with an agate mortar, placed in an alumina crucible, and then calcined in a temperature range of 1200° C. to 1250° C. for 2 hours to produce Mg₂SiO₄. Next, the calcined Mg₂SiO₄ powder used as the main component and TiO₂ and glass (SiO₂—BaO—CaO—Al₂O₃—Li₂O) containing Al₂O₃, Li₂O, and oxides used as the subcomponents were prepared at a proper mass ratio and then mixed together with ethanol in a ball mill for 24 hours. The resultant mixed slurry was dried by stepwisely heating at 80° C. to 120° C. and then disintegrated with an agate mortar to produce a dielectric composition.

The resultant dielectric composition powder was added to an acrylic or ethyl cellulose organic binder or the like, and the resultant mixture was formed into a sheet, producing a green sheet. A method for forming the green sheet is a wet forming method such as a sheet method, a printing method, or the like. Then, a conductive paste containing Ag was applied to the formed green sheet so as to form an internal electrode with a predetermined shape. If required, a plurality of the green sheets each having the conductive paste applied thereon were formed.

The plurality of the green sheets were laminated and pressed to form a laminate. The resultant laminate was cut into a desired size and chamfered, and then the binder was removed from the laminate at 350° C. in air. Then, the laminate was fired by heating to 900° C., maintaining at 900° C., and then cooling to room temperature to produce a sintered body. Table 1 shows the amounts of the subcomponents contained in the resultant dielectric ceramic.

After the sintered body was cooled, if required, external electrodes etc. were formed on the resultant dielectric ceramic, thereby completing an electronic component including the dielectric ceramic and the external electrodes etc. formed thereon.

[Evaluation]

The sintering density ρs, Q value, water resistance, and insulation after high-temperature humidity load test of each of the resultant dielectric ceramics were determined.

[Sintering Density ρs]

A test piece after firing was cut into a size of about 4.5×3.2×0.8 mm in the length, width, and thickness (LWT) directions. The dimension in each of the directions was measured with a micrometer, and mass was measured with an electronic balance to determine a bulk density as a sintering density ρs (unit: g/cm³). Here, L represents the length direction of the test piece, W represents the width direction, and T represents the thickness direction of the test piece. The results of measurement are shown in Table 1. In addition, a relative density was calculated based on a reference value of 3.35 g/cm³, and a value of 95% or more was determined as “good sinterability”.

[Q Value]

The Q value was measured by a cavity resonator perturbation method. A rod-shaped test piece having a 0.8-mm square size and a desired length was inserted into a cavity resonator, and a change in Q value in the cavity resonator was measured. The measurement frequency was 1.9 GHz, and the Q value was measured three times and averaged. The results of measurement are shown in Table 1. The Q values of 1000 or more were determined as good characteristic.

[Determination of Water Resistance]

A test piece after firing was cut into about 4.5×3.2×0.8 mm in the LWT directions, preparing a chip. The chip was allowed to stand at room temperature in an aqueous solution adjusted to desired pH for 24 hours. The chip treated with the solution was broken with a nipper, and the broken surface layer was observed with a scanning electron microscope (trade name: JSM-T300, manufactured by Japan Electron Datum Co., Ltd.). A SEM image (1000 times) of the surface layer after firing was taken to determine the presence of solution penetration.

[Determination of Insulation After High-Temperature Humidity Load Test]

Chips (n=22) provided with capacitor patterns were formed for each of the material compositions so that test pieces after firing had about 4.5×3.2×0.8 mm in the LWT directions. Electrodes were formed as patterns in an internal layer. After external terminals were formed on each of the chips, plating was performed, and then the chips (n=22) were mounted by soldering on a substrate for a reliability test. Then, the substrate was allowed to stand in a test bath at a temperature of 60° C. and a humidity of 95% for 2000 hours while a voltage of 5 V was applied to the chips. When the value of insulation resistance was decreased by two digits or more from the value before the test, insulation resistance was regarded as deteriorating. When even one chip of the 22 chips deteriorated, insulation was determined to be “no insulation”.

TABLE 1

| | Main | | | | | | | | |
|---|---|---|---|---|---|---|---|---|---|
| | component | Subcomponent | | | | Relative | | | Determination of |
| | Mg₂SO₄ | TiO₂ | Al₂O₃ | Li₂O | Sintering | density | Q value | Determination | insulation after |
| | (parts | (parts | (parts | (parts | density ρs | (100% at | (@1.9 | of water | high-temperature |
| | by mass) | by mass) | by mass) | by mass) | (g/cm³) | 3.35 g/cm³) | GHz) | resistance | humidity load test |
| Example 1 | 100 | 0.5 | 1 | 1 | 3.31 | 98.8 | 1523 | Good without | Good without |
| | | | | | | | | solution | deterioration |
| | | | | | | | | penetration | in insulation |
| Example 2 | 100 | 1 | 1 | 1 | 3.32 | 99.1 | 1555 | Good without | Good without |
| | | | | | | | | solution | deterioration |
| | | | | | | | | penetration | in insulation |
| Example 3 | 100 | 3 | 1 | 1 | 3.33 | 99.4 | 1602 | Good without | Good without |
| | | | | | | | | solution | deterioration |
| | | | | | | | | penetration | in insulation |
| Example 4 | 100 | 5 | 1 | 1 | 3.34 | 99.7 | 1610 | Good without | Good without |
| | | | | | | | | solution | deterioration |
| | | | | | | | | penetration | in insulation |
| Example 5 | 100 | 1 | 0.5 | 1 | 3.29 | 98.2 | 1635 | Good without | Good without |
| | | | | | | | | solution | deterioration |
| | | | | | | | | penetration | in insulation |
| Example 6 | 100 | 1 | 1 | 1 | 3.30 | 98.5 | 1610 | Good without | Good without |
| | | | | | | | | solution | deterioration |
| | | | | | | | | penetration | in insulation |
| Example 7 | 100 | 1 | 2 | 1 | 3.33 | 99.4 | 1650 | Good without | Good without |
| | | | | | | | | solution | deterioration |
| | | | | | | | | penetration | in insulation |
| Example 8 | 100 | 1 | 3 | 1 | 3.35 | 100.0 | 1659 | Good without | Good without |
| | | | | | | | | solution | deterioration |
| | | | | | | | | penetration | in insulation |
| Example 9 | 100 | 1 | 1 | 2 | 3.27 | 97.6 | 1667 | Good without | Good without |
| | | | | | | | | solution | deterioration |
| | | | | | | | | penetration | in insulation |
| Example 10 | 100 | 1 | 1 | 3 | 3.28 | 97.9 | 1675 | Good without | Good without |
| | | | | | | | | solution | deterioration |
| | | | | | | | | penetration | in insulation |
| Comparative | 100 | 1 | 1 | 0.5 | 2.84 | 84.8 | 568 | Poor with | Poor with |
| Example 1 | | | | | | | | solution | deterioration |
| | | | | | | | | penetration | in insulation |
| Comparative | 100 | 1 | 3 | 4 | 3.23 | 96.4 | 578 | Poor with | Poor with |
| Example 2 | | | | | | | | solution | deterioration |
| | | | | | | | | penetration | in insulation |
| Comparative | 100 | 0.1 | 1 | 1 | 3.24 | 96.7 | 605 | Poor with | Poor with |
| Example 3 | | | | | | | | solution | deterioration |
| | | | | | | | | penetration | in insulation |
| Comparative | 100 | 6 | 1 | 1 | 2.99 | 89.3 | 765 | Poor with | Poor with |
| Example 4 | | | | | | | | solution | deterioration |
| | | | | | | | | penetration | in insulation |
| Comparative | 100 | 1 | 0.1 | 1 | 3.25 | 97.0 | 675 | Poor with | Poor with |
| Example 5 | | | | | | | | solution | deterioration |
| | | | | | | | | penetration | in insulation |
| Comparative | 100 | 1 | 4 | 1 | 3.01 | 89.9 | 435 | Poor with | Poor with |
| Example 6 | | | | | | | | solution | deterioration |
| | | | | | | | | penetration | in insulation |
| Comparative | 100 | 0 | 0 | 0.38 | 2.94 | 87.8 | 455 | Poor with | Poor with |
| Example 7 | | | | | | | | solution | deterioration |
| | | | | | | | | penetration | in insulation |
| Comparative | 100 | 0 | 0 | 1.2 | 3.21 | 95.8 | 520 | Poor with | Poor with |
| Example 8 | | | | | | | | solution | deterioration |
| | | | | | | | | penetration | ininsulation |

In Table 1, Examples 1 to 10 show Q values of 1000 or more depending on the amounts of the main component and the subcomponents. As for water resistance, no solution penetration was confirmed by taking a SEM image (1000 times) of the surface layer, and deterioration in insulation by two digits or more from the value before the test was not observed. Therefore, it was confirmed that each of the characteristics is improved.

The results shown in Table 1 indicate that since the amounts of the main component and the subcomponents in Examples 1 to 10 fall in the respective ranges of the present invention, the effect of the present invention is exhibited.

The results shown in Table 1 indicate that since the amounts of the main component and the subcomponents in Comparative Examples 1 to 8 are out of the respective ranges of the present invention, the effect of the present invention is not exhibited.

What is claimed is:

1. A dielectric ceramic comprising:
Mg₂SiO₄ as a main component; and
TiO₂ , Al₂O₃, and Li₂O as subcomponents,
wherein, based on 100 parts by mass of the main component, the TiO₂ content is 0.5 parts by mass or more and 5.0 parts by mass or less in terms of oxide, the Al₂O₃ content is 0.5 parts by mass or more and 3.0 parts by mass or less in terms of oxide, and the Li₂O content is 1.0 part by mass or more and 3.0 parts by mass or less in terms of oxide.

2. An electronic component comprising a dielectric layer composed of the dielectric ceramic according to claim 1.
